(19) United States
(12) Patent Application Publication
(10) Pub. No.: US 2020/0096095 A1
(43) Pub. Date: Mar. 26, 2020

(54) CONTROL OF A HYDRAULIC TRANSMISSION AS A FUNCTION OF THE AGEING OF THE TRANSMISSION FLUID

(71) Applicant: POCLAIN HYDRAULICS INDUSTRIE, Verberie (FR)

(72) Inventor: Bastien CLAPIT, Verberie (FR)

(21) Appl. No.: 16/620,426

(22) PCT Filed: Jun. 8, 2018
(86) PCT No.: PCT/EP2018/065208

§ 371 Date: Dec. 6, 2019

(30) Foreign Application Priority Data
Jun. 9, 2017 (FR) 1755157

(51) Int. Cl. F16H 59/72; F16H 61/38; B60Q 9/00; B60K 23/08; F16H 57/04; G07C 5/08

(52) U.S. Cl. CPC F16H 59/72; F16H 61/38; B60Q 9/00; B60K 2023/0858; F16H 57/0405; G07C 5/085; B60K 23/08

(57) ABSTRACT

The invention relates to a system (2) for controlling a disengageable hydraulic transmission (1) for a vehicle, involving the circulation and the pressurisation of a transmission fluid, said system (2) comprising: —means (21) for collecting information relative to the operation of the hydraulic transmission (1) since the last time the transmission was serviced, —means (22) for estimating an ageing state of the transmission fluid based on the information collected, and —means (23) for controlling the disengageable hydraulic transmission (1) as a function of the estimated ageing state.

### FIELD OF THE INVENTION

The invention relates to the field of hydraulic transmissions for vehicles. More particularly, the invention relates to the control and maintenance of transmissions of this type.

### TECHNOLOGICAL BACKGROUND

Current vehicles use numerous working fluids, among them lubrication fluids or transmission fluids. Although they have substantially identical composition, the functions of these fluids differ and lead to different sets of technical problems.

Transmission fluids are in particular used in systems involving their circulation and pressurization. Consequently, these fluids are designed to support very high pressures and very high temperatures.

This type of fluid is in particular used in geared transmissions and in hydraulic transmissions where they can undergo high shear which tend to shorten the carbon chains which compose them. That is one of the reasons for which the viscosity of such fluids decreases during the operation of vehicle hydraulic transmissions. This reduction in viscosity can be such that the parts of the hydraulic transmission come into contact with one another, thus causing their premature wear.

Added to this disadvantage is the particulate pollution originating in the metal filings brazed by the circulation of fluid on the parts, and from general or localized oxidation phenomena when the transmission is not used, and the oil does not circulate in the different components.

It is therefore necessary to proceed with regular maintenance to flush the working fluids so as to guarantee the performance of the vehicles, and particularly of their hydraulic transmissions. Current maintenance methods have numerous challenges.

First of all, with a view to reducing costs, constructors seek to reduce as much as possible the interval between each maintenance while still ensuring the integrity of hydraulic transmission systems throughout their lifetimes.

In addition, constructors require being able to dispose the same equipment throughout the world to have system commonality and reduce costs. Hydraulic transmission fluids must therefore be capable of resisting and ensuring the performance of hydraulic transmission systems under very diverse conditions, and in all climates. By way of an example, use in very cold weather, combined with a tendency of the system to stabilize at very hot temperatures, drives the use of fluids with a very high index of viscosity. These indexes are obtained by using a very dense “additivation.” The use of additive components reinforces the sensitivity to shear and to strong pressure discharges.

Finally, to make hydraulic assistance systems very compact, it is necessary to seek very high operating pressures, for example on the order of 450 bar. Operation at these pressure levels requires, having sufficient fluid film thicknesses between moving parts under load, i.e. at least greater than the roughness of the surface, to ensure a completely hydrodynamic lubrication regime, i.e. not including any direct metal-to-metal contact. Utilization conditions, in terms of cleanliness level and intrinsic quality of the fluid (viscosity, smoothness, lubricating property . . . ) must therefore be optimal to ensure full power operation of the assistance function of the transmission systems, without risking degradation.

To confront these challenges, it is for example known, in a 4×4 hydraulic assistance system, to integrate the possibility of being activated or deactivated depending on the rolling or utilization case, and on the necessity of having additional drivability available on the axle not connected to the standard transmission. This activation is accomplished by a coupling member, which is controlled through a computer or directly by an action of the user. The computer generally acts as a supervisor to verify that the activation of the system which could be required in a given situation would not compromise the integrity of the system. This monitoring is accomplished through a set of sensors which make available information on the instantaneous condition of the system.

This type of monitoring, however, does not take into account the peculiarities of the user and does not propose control and/or maintenance suited to the use of the hydraulic transmission.

Also known, from document EP 2 159 758, is a method for supervising a transmission fluid allowing guaranteeing that the longevity of the fluid corresponds to the flushing schedule provided by a user. More precisely, the method provides for a first step consisting of estimating the wear of the transmission fluid, and a second step consisting of controlling a retarder using the fluid. If the flushing interval is approaching and the fluid is not sufficiently spent, the control step consists of increasing the performance of the retarder so as to accelerate the wear of the fluid. On the contrary, if the fluid is very spent, but the flushing interval is not expected soon, the control step consists of reducing the performance of the retarder so as to prevent the wear of the fluid.

This type of monitoring, however, does not allow guaranteeing the mechanical integrity of the systems using the transmission fluid.

There is therefore a need for a control and/or maintenance system and method for hydraulic transmission systems for vehicles which allows optimizing their operation and preserving their integrity, while still being suited to the profile of the user.

### SUMMARY OF THE INVENTION

One aim of the invention is to propose a control system and method for hydraulic transmissions for vehicles, particularly disengage able transmissions, which takes into account the ageing state of the fluid in the loads that are imposed on it. This taking into account includes partial or total limitations of operation of the transmission during its use, so as to guarantee its mechanical integrity.

Another aim of the invention is to propose maintenance of hydraulic transmissions for vehicles which is suited to each user.

Another aim of the invention is to be able to use a hydraulic transmission regardless of the ageing state of the transmission fluid, i.e. even beyond the flushing interval provided for and/or even when the transmission fluid is degraded.

To this end, the invention proposes a system for controlling a disengageable hydraulic transmission for vehicles, involving the circulation and the pressurization of a transmission fluid, said hydraulic transmission comprising:
a first hydraulic machine connected to a first axle of the vehicle, and a second hydraulic machine connected to a second axle of the vehicle, to provide an additional and temporary wheel power and
a set of pipes capable of routing the transmission fluid between the two hydraulic machines by means of at least one high-pressure line,
   said system comprising:
means for collecting information relating to the operation of the hydraulic transmission since the maintenance of the transmission,
means for estimating an ageing state of the transmission fluid based on the information collected, said means comprising means for estimating the viscosity of the transmission fluid, and
control means for the disengageable hydraulic transmission depending on the estimated ageing state so as to adapt the operation of the hydraulic transmission to preserve the longevity of the transmission parts of the hydraulic machines.

A control system of this type is based on a better understanding of the evolution of the state of the fluid during the life of the hydraulic transmission. This results in a better control of lubrication of transmission part during the entire duration of the interval between each maintenance. What is thereby made possible is an advantageous extension of the flushing interval and a reduction in the costs of the properties of the system for the user.

At the end of the current flushing, this extension of the longevity of the hydraulic transmission can be allowed by a degraded operating mode which guarantees the preservation of the parts of the system, bringing in particular a reduction in the overall wear of the transmission.

Certain preferred but non-limiting features of the control system described above are the following, taken individually or in combination:
the means for collecting information relating to the operation of the hydraulic transmission comprise means for collecting information relating to the pressure or the temperature of the transmission fluid so as to establish a history of the temperature or pressure of the transmission fluid since the last maintenance of the transmission.
the control means of the disengageable hydraulic transmission comprise means for engaging or disengaging the disengageable hydraulic transmission.
the control means of the disengageable hydraulic transmission comprise means for limiting the user of the disengageable hydraulic transmission depending on the speed of the vehicle.
the control means of the disengageable hydraulic transmission comprise means for limiting the transmission torque.
the control means of the disengageable hydraulic transmission comprise alerting means for recommending flushing of the transmission fluid.
the means for estimating an ageing state of the transmission fluid comprise means for estimating the evolution of the viscosity of the fluid during operation of the transmission.
the set of pipes capable of routing the transmission fluid between the two hydraulic machines of the hydraulic transmission comprises a high-pressure line and a low-pressure line defining a closed loop.
the set of pipes capable of routing the transmission fluid between the two hydraulic machines defines an open loop with low-pressure return to an oil reservoir.
it further comprises means for collecting information relating to the viscosity of the fluid defining maximum and minimum fluid temperature thresholds beyond which the continuity and safety of the system are involved.

The invention also applies to a vehicle comprising a disengageable hydraulic transmission, and further comprising a system as described previously.

Finally, the invention relates to a method for controlling a disengageable hydraulic transmission for vehicles, involving the circulation and the pressurization of a transmission fluid, said hydraulic transmission comprising:
a first hydraulic machine connected to a first axle of the vehicle, and a second hydraulic machine connected to a second axle of the vehicle, to provide additional and temporary wheel power, and
a set of pipes capable of routing the transmission fluid between the two hydraulic machines by means of at least one high-pressure line,
   the method comprising the steps of:
collecting information relating to the operation of the hydraulic transmission since a last maintenance of the transmission,
estimating an ageing state of the transmission fluid based on the information collected, said estimation step comprising a step of estimating the viscosity of the transmission fluid, and
controlling of the disengageable hydraulic transmission depending on the estimated ageing state so as to adapt the operation of the hydraulic transmission to preserve the longevity of the transmission parts of the hydraulic machines.

Certain preferred but non-limiting features of the control method described above are the following, taken individually or in combination:
the step of collecting information relating to the operation of the hydraulic transmission comprises collecting information relating to the pressure or to the temperature of the transmission fluid so as to establish a history of the temperature or pressure of the transmission fluid since the last maintenance of the transmission.
the step of estimating the ageing state of the transmission fluid comprises estimating the viscosity of the transmission fluid depending on the temperature of the transmission fluid and the established history.
the control step comprises steps of engaging or disengaging the transmission system or a step of limiting the transmission torque, or an alerting step for recommending flushing of the transmission fluid.

### BRIEF DESCRIPTION OF THE DRAWINGS

Other features, aims and advantages of the present invention will appear more clearly upon reading the detailed description that follows, and with reference to the appended drawings given by way of non-limiting examples in which:

FIG. 1 illustrates examples of viscosity curves as a function of temperature for a new hydraulic fluid and a sheared hydraulic fluid,

FIG. 2 illustrates examples of viscosity curves as a function of temperature for a new hydraulic fluid and an oxidized hydraulic fluid,

FIG. 3 illustrates schematically the different steps of an exemplary embodiment of the control method of a hydraulic transmission for vehicles according to the invention,

FIG. 4 shows schematically the different steps of a first embodiment of a control method of the hydraulic transmission or vehicles,

FIG. 5 illustrates an example of evolution of maximum temperature thresholds for deactivation of the assistance associated with a hydraulic transmission for vehicles during operation, controlled according to a first embodiment of a control method for a hydraulic transmission for vehicles,

FIG. 6 shows schematically the different steps of a second embodiment of a control method for a hydraulic transmission for vehicles,

FIG. 7 illustrates an example of evolution of the maximum temperature thresholds for deactivation of the assistance associated with a hydraulic transmission for vehicles in operation, controlled according to a second embodiment of a control method for a hydraulic transmission for vehicles,

FIG. 8 shows schematically the different steps of a third embodiment of a control method of a hydraulic transmission for vehicles,

FIG. 9 illustrates an example of cartography providing the transmission fluid pressure in the high-pressure loop of a hydraulic transmission for vehicle based on the speed of the vehicle and the difference in speed between the front and rear axles of the vehicle,

FIG. 10 illustrates an example of a history of transmission fluid pressure obtained during a third embodiment of a control method of a hydraulic transmission.

FIG. 11 shows schematically the different steps of a personalized maintenance method of a hydraulic system for vehicles, and

FIG. 12 illustrates schematically the different components of an embodiment of a control and maintenance system for a vehicle according to the invention.

### DETAILED DESCRIPTION OF AN EMBODIMENT

Control S and maintenance M systems 2, 3 and methods for hydraulic transmissions 1 for vehicles will now be described.

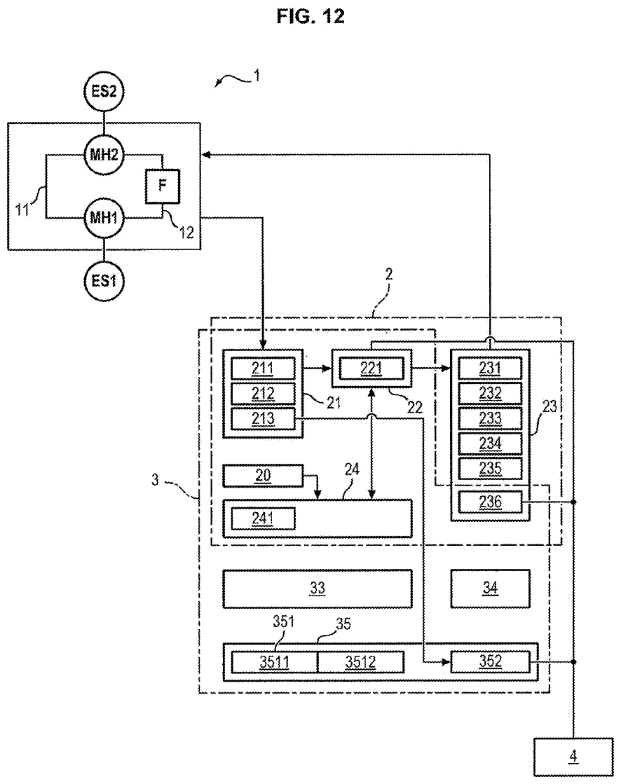

With reference to FIG. 12, these systems 2, 3 can be implemented for all types of hydraulic transmission 1 used for all types of vehicles, in open or closed loop, and using hydraulic machines MH1, MH2 with fixed or variable displacement. More particularly, these systems 2, 3 can be implemented to the benefit of disengageable hydraulic transmissions 1. Disengageable hydraulic transmissions 1 are complementary hydraulic transmissions 1 which allow increasing the drivability of a vehicle by providing an additional and temporary wheel power. More particularly still, these systems 2, 3 can be implemented on hydraulic transmissions 1 of the “bicycle chain” type, which use hydraulic machines MH1, MH2 with fixed displacements connecting two axles, so as to transfer torque from one axle to the other. A system of this type allows for example temporarily transforming a 4×2 vehicle into a 4×4 vehicle. In any case, such transmissions comprise a first hydraulic machine or pump MH1 connected to one vehicle axle or to a power source ES1, a second hydraulic machine or motor MH2 connected to the other vehicle axle ES2, an oil filter F for the circulation of hydraulic fluid, and a set of pipes capable of routing the transmission fluid by means of at least one high-pressure line (11). This, in one embodiment, this set of pipes comprises a high-pressure line 11 and a low-pressure line 12 defining a closed loop. In an alternative embodiment, this set of pipes defines an open loop with a low-pressure return to an oil reservoir. These transmissions allow in particular providing additional drivability and propulsion in driving the vehicle under difficult environmental conditions (mountain, trails, etc.).

In order to optimize the operation of hydraulic transmissions 1 of this type, it is advantageous to propose suitable control and maintenance strategies. These strategies allow adjusting the particular use of hydraulic transmissions 1 of this type for a given user or utilization. This adaptation can in particular take into account the ageing state of the fluid in circulation in systems of this type.

The ageing state of a transmission fluid is characterized by several parameters, including:
the shearing of the fluid,
the oxidation of the fluid, and
the particulate contamination.
   Knowledge of the set of these parameters, alone or in combination and of their evolution during operation of the transmission, allows in particular estimating the viscosity of the transmission fluid as a function of its temperature. The viscosity of the transmission fluid can also be determined directly by sensors configured to measure it.

In any case, knowledge of the ageing state of the transmission fluid, correlated to optimal operation criteria depending on said ageing state, allows adapting the operation of the hydraulic transmission so as to preserve the longevity of the transmission 1 parts. In fact, when transmission 1 parts come into contact, if the viscosity of the transmission fluid is too low relative to the contact pressure, the transmission fluid is ejected from the contact zone, and solid friction degrades the part. Conversely, when the transmission fluid has a high viscosity, the risk of obstructing transmission openings increases, and mechanical parts degrade due to the loss of transmission fluid supply. Optimal operation criteria can be defined directly by the user, or be supplied by the constructor. These criteria can also be adjusted during use. These criteria can for example be temperature limits between which the transmission fluid has a viscosity compatible with good operation of the transmission 1 (i.e. with no risk of mechanical degradation), regardless of the ageing state of the transmission fluid.

The control of a transmission 1 of this type can comprise different actions, implemented by a set of means 23 (231, 232, 233, 234, 235, 236) configured for this purpose, and comprised within a control system 2. I the case of disengageable hydraulic transmission 1 systems, it is possible to allow the engagement of the cutoff of assistance associated with the hydraulic transmission. This is then referred to as the engagement or disengagement of the disengageable hydraulic transmission, implemented by means 231 configured for this purpose. It is also possible to limit, by means 232 configured for this purpose, the speeds at which the vehicle is allowed to use hydraulic assistance. Moreover, it is possible to limit, by means configured for this purpose 233, the transmission torque, thus entailing a degraded assistance mode. In addition, a member 234 regulating the fluid temperature can be implemented. In addition, it is also possible to limit, by means 235 configured for this purpose, for example anti-slip regulation (ASR) systems, the power of the heat engine. Finally, the control can suggest maintenance to the user, for example by means of an alerting device 236 configured for this purpose. These actions can be implemented alone or in combination, by all or part of the means 23 configured for this purpose.

In any case, the control ensures that the transmission 1 operates only when the viscosity of the fluid is compatible with the safety and continuity of the transmission (i.e. without damaging the mechanical transmission parts).

For example, if the viscosity of the fluid is too low, control can consist of limiting the transmission torque. In fact, the transmission torque determines the contact pressure and, from that, the ejection of fluid out of the contact zones of the transmission 1 parts. However, if the fluid cools, the viscosity of the fluid increases and control can then consist of increasing the transmission torque. Thus it is for example possible to associate, with each given fluid viscosity, a maximum transmission torque allowed by the control of the transmission 1. In another embodiment, if the viscosity is too high, the control can consist of limiting the speeds at which the vehicle is allowed to use hydraulic assistance. In fact, the speed of the vehicle determined the pumping speed of the fluid through the transmission 1 and, from that, the potential appearance of cavitation bubbles if the fluid supply is not sufficient. These cavitation bubble cause depriming of the transmission, the appearance of vibrations of seizing and abrading of mechanical parts. However, if the fluid is heated during operation of the transmission, the viscosity of the fluid is reduced and control can then consist of allowing hydraulic assistance to be used at higher speeds. Thus it is also possible to associate, with each given fluid viscosity, a maximum speed at which the vehicle is allowed to use hydraulic assistance.

In this manner, the control of the hydraulic transmission 1 can allow benefiting from hydraulic assistance even when the vehicle is operating in an environment with low temperatures while the fluid has a high viscosity. Likewise, it is possible to have the benefit of hydraulic assistance even when the vehicle is operating in an environment with high temperatures while the fluid has a low viscosity. This type of situation can in particular be encountered when a vehicle is making trips over great distances, or when the selection of transmission fluid does not correspond to the reality of operation of the hydraulic transmission 1.

The different ageing states of hydraulic transmission fluids will now be described in more detail.

Shear

A fluid subjected to strong recurrent discharges, such as for example passage through a valve or in zones with small interstices, undergoes a strong speed gradient between boundary layers. This speed gradient has as its consequence a shearing and a destruction of polymer chains contained in the fluid, causing a loss of viscosity.

By way of a non-limiting example, it is customarily recognized that the minimum allowable kinematic viscosity limit, when hot, for a transmission fluid is 9 centistokes, for use limited in time to a short period.

Fluids with a very high viscosity index are very sensitive to shear, and can degrade until they reach viscosities below 9 centistokes. The consequences of passing such a threshold are decreases in performance of the transmission system, increased sensitivity to particulate pollution, and risks of seizing and of blocking of critical components. These losses can reach up to 40% of the initial viscosity over the entire life of the system, depending on the fluid selected.

The main parameter influencing shear is the pressure in the high-pressure loop of the transmission system. In fact, this pressure conditions the speed gradients of passage in critical zones such as zones with low clearance, valves or leaks.

One means for monitoring the shear of a fluid in circulation in a hydraulic transmission system is therefore to follow the history of pressure in the high-pressure loop.

Oxidation

Temperatures in the hydraulic transmission assistance systems for vehicles can be very high, particularly due to the small volumes of fluid circulated, the absence of exchange valves and, especially, proximity of the system with the hot members of the heat engine.

By way of a non-limiting example, it is customary to stabilize the temperature of such transmission system around 50° C. in order to obtain better efficiencies, but also for the longevity of the fluid and sensitive components. It is then considered that each time the fluid exceeds the threshold of 70° C. by a gap of 10° C., its longevity decreases by half at each 10° C. interval.

One manner of estimating the degree of oxidation of the fluid is then to account for the number of times a certain critical threshold, previously defined, is exceeded, for example 60° C. or 70° C. It can then also be useful to follow the history of temperatures of the transmission fluid.

Particulate Contamination

Certain transmission fluids can also be contaminated by the presence of catalytic metal pollutants of the iron or copper type.

By way of a non-limiting example, it is considered that, in the case of iron, the lifetime of the fluid is reduced by 30% when contamination passes from 50 to 100 ppm. This lifetime is reduced by an additional 10% each time the pollution increases by 50 ppm beyond the threshold of the first 100 ppm.

As hydraulic transmission systems have a tendency to be broken in, they emit many particles at the beginning of their lives, the emission stabilizing thereafter.

Another non-limiting example of a cause of contamination is the reduction of the inner diameter of elements of the system placed below the chassis of the vehicle. The speeds of fluids in these zones are then too high and consequently cause degradation of the fluid and premature abrasion of the fluid pipes of the system. The fluid can then be contaminated by large-dimensioned particles of elastomers.

In any case the oil filter of the hydraulic circuit allows limiting the effect of pollution of this type.

One manner of predicting the gravimetry of particles found in the filter, and their nature, consists of accounting for the number of flushings previously carried out.

The effects of oxidation and of particulate contamination are different from the effects caused by shear.

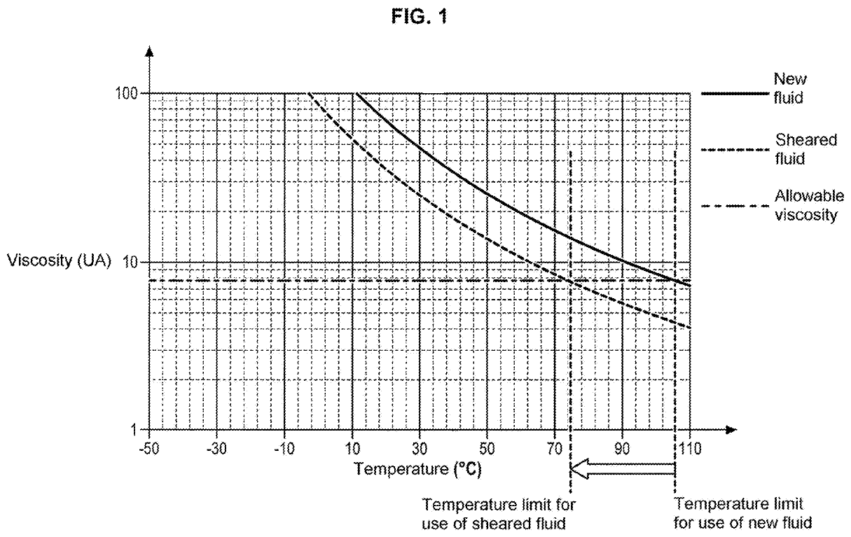

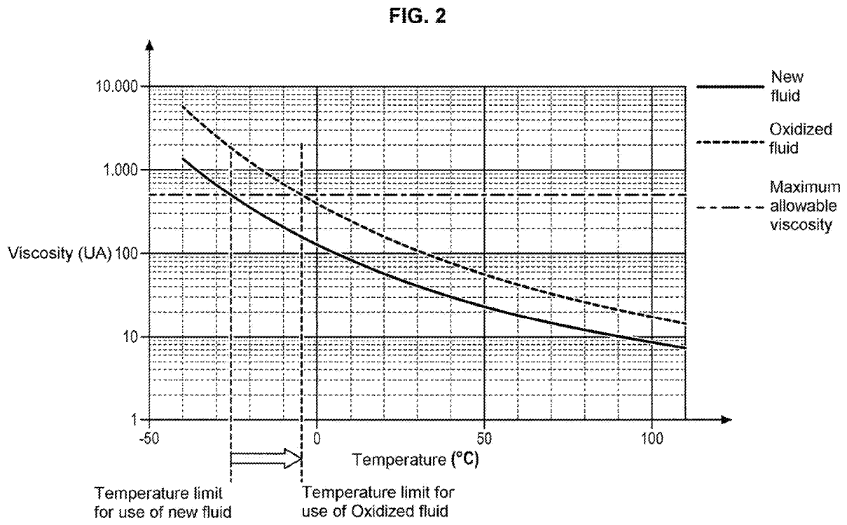

FIGS. 1 and 2 show curves providing non-limiting examples of changes in the viscosity of a fluid as a function of temperature for two different ageing states. The values applied to these curves are purely arbitrary and serve only to illustrate the physical phenomena linked to the ageing modes of a transmission fluid.

FIG. 1 illustrates for example that shear has a tendency to reduce the viscosity curve as a function of temperature.

FIG. 2 illustrates that oxidation and particular contamination have a tendency to elevate this curve, particularly due to the thickening of the fluid.

In the case of ageing due to shear, for a disengageable transmission system, it can be preferable to reduce the maximum temperature at which the transmission system is cut off. For example, and without limitation, it is noted in FIG. 1 that a minimum threshold of viscosity, constituting in this particular case the optimal criterion of operation of the transmission, requires passing the deactivation temperature of the system from 100° C. to 75° C. A person skilled in the art understands that these values are given only by way of a non-limiting example and that, depending on the type of fluid used, these deactivation limits can vary.

Control actions associated with ageing by shear can therefore be the following:
allowing the engagement of hydraulic assistance associated with the transmission system,
disengaging the transmission system in the event of attaining the limiting temperature threshold,
controlling a temperature regulating member so as to reduce the temperature of the fluid in circulation in the system.

In the case of ageing by oxidation and/or contamination, it is preferable to limit the engagement of the disengageable hydraulic transmission, when cold.

The control actions associated with ageing by oxidation and contamination can therefore be the following:
raising the minimum activation temperature,
limiting the speed of the pump in the engaged mode during the cold starting phase of the system, i.e. using hydraulic assistance in degraded mode, and
limiting pressure by limiting the speed gap between axles.
   One non-limiting example of hydraulic assistance in degraded mode consists of limiting the suction head losses of the main pump. To this end, the control system can for example limit the speed to 20 km/h with a new fluid during the first minutes of use while, with an aged fluid, i.e. more viscous when cold, it is preferable to reduce this limitation to 10 km/h.

In any case, the aim is to adjust the operation of the transmission system depending on the viscosity of the fluid o that said viscosity remains in an acceptable range for preserving the longevity of the transmission parts. Effectively, ageing due to shear, or due to oxidation and contamination, causes a reduction in the range of operating temperature of the transmission system. For example, in the case of a disengageable hydraulic transmission system, the minimum engagement threshold of the transmission is increased and the maximum disengagement threshold is reduced.

The different steps of a control method S of a hydraulic transmission for vehicles will now be described in more detail, for the non-limiting example of a disengageable hydraulic transmission 1, like for example the “bicycle chain” type involving the circulation and pressurization of a transmission fluid.

The method S described can be implemented by a system 2 having means configured to accomplish the different steps of the method. These means can in particular comprise a computer 24 having a memory 241 for storing control instructions. Depending on the size of this memory 241, different levels of complexity of the method can be considered.

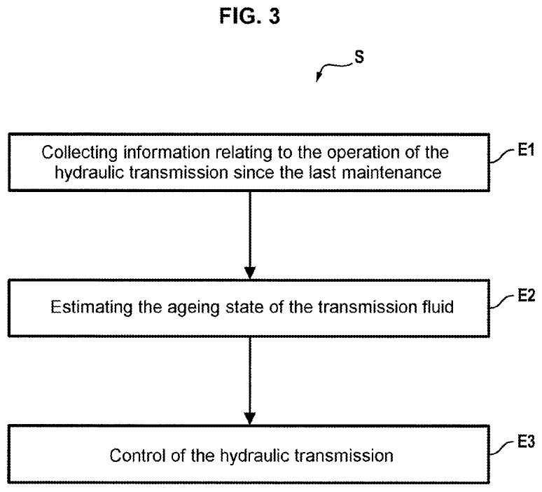

With reference to FIG. 3, during a first step E1, information relating to the operation of the hydraulic transmission since a last maintenance of the transmission, by means 21 configured for this purpose.

During a second step E2, the ageing state of the transmission fluid is estimated, by means 22 configured for this purpose, based on the information collected during the collection step E1.

During a last step E3, the disengageable hydraulic transmission 1 is controlled, by means 23 configured for this purpose, depending on the ageing state of the transmission fluid estimated during the estimation step E2. This step E3 advantageously allows using the transmission 1 regardless of the state of the transmission fluid, i.e. even when the flushing interval is exceeded and/or even when the transmission fluid is degraded.

Hereafter, the control action E3, implemented by means 23, 231 configured for this purpose, consists of engaging and disengaging the hydraulic transmission at adjusted temperature thresholds depending on the use. A person skilled in the art will understand, upon reading the following, that the spirit of the invention is not, however, limited to such actions and that any control action E3 previously described can be considered depending on the estimated ageing state of the fluid.

Different embodiments of the control method S of a disengageable hydraulic transmission 1 will now be described.

Duration of the Flushing Interval

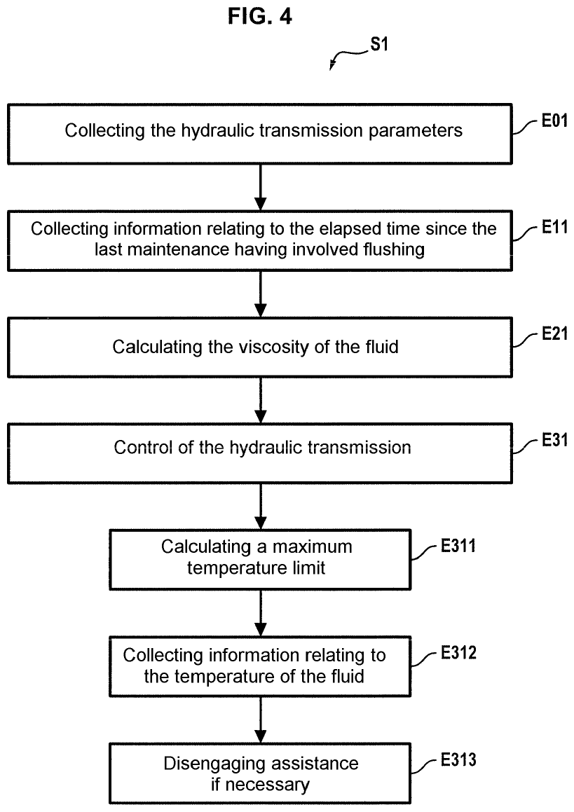

A first embodiment S1 of a control method S of a hydraulic transmission for vehicles is illustrated in FIG. 4.

A preliminary step E01 of a method of this type consists of collecting hydraulic transmission parameters. These parameters comprise the reference of the fluid in circulation, and the associated ageing table, and information relating to the viscosity of the fluid defining the maximum and minimum temperature thresholds of the fluid above which the continuity and safety of the system are threatened. More precisely, this information supplies, for each value of viscosity of the transmission fluid, a range of transmission fluid temperature guaranteeing use of the transmission 1 which will not damage the mechanical parts.

These parameters can be supplied directly by the user, or the constructor, at the moment when the vehicle is placed in service or at any time in the life of the hydraulic transmission 1. In any case, the control system 2 has means 20 for collecting these parameters. Advantageously, these means 20 are connected to the computer 24 for storing the parameters received in the memory 241.

The ageing table supplies the evolution of the viscosity of the fluid depending on time and on different uses of the transmission, starting with a new flushing. By way of a non-limiting example, these uses can be comprised between a severe level and a light level. The severe level can correspond to regular daily use of the assistance associated with the transmission, while the light level can correspond to rare, for example monthly, use of the assistance associated with the transmission.

A first step E11 consisting of collecting information relating to the operation of the hydraulic transmission consists of collecting information relating to the elapsed time since the last maintenance having included flushing, by means 211 configured for this purpose.

A second step E21 consisting of estimating the ageing state of the transmission fluid consist of calculating, by means of the computer 24, based on the information collected in the collection step E11, and on the ageing table received during the preliminary step E01, the viscosity of the fluid. The management of the collected information at the collection step E11, the calculation orders sent by the computer 24, and the management of the response returned by the computer 24, are all actions managed by the circulating fluid aging state estimation means 22, configured for this purpose.

A third hydraulic transmission control step E31, implemented by the control means 23, 231, comprises a first sub-step E311 consisting of calculating, within the computer 24, the value of a maximum temperature limit beyond which hydraulic assistance is disengaged, based on the value of the fluid viscosity estimated in the estimation step E21. A second sub-step E312 consisting of collecting information relative to the temperature of the fluid in circulation is then implemented by means 213 configured for this purpose. The hydraulic transmission is then controlled E313 to disengage the hydraulic assistance if necessary, depending on the maximum temperature calculated during the first sub-step, calculation step 311, and on the information relating to the temperature of the fluid in circulation collected during the second collection sub-step E312.

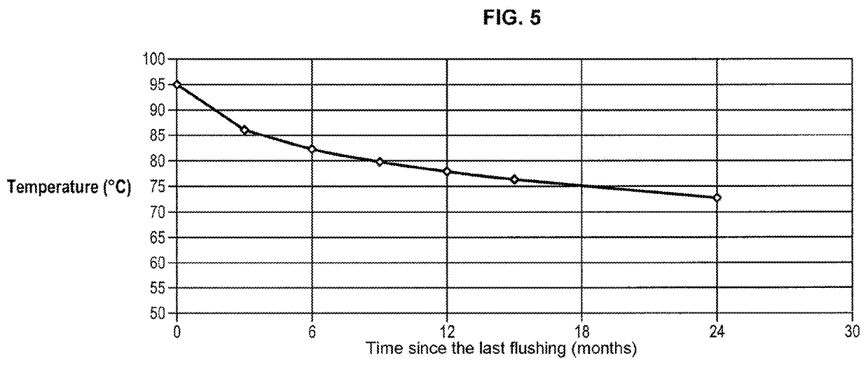

FIG. 5 illustrates an example of a curve providing the maximum temperature limit for disengagement of a hydraulic transmission for vehicles as a function of time, in the case where the level of use is severe. The evolution over time is supplied as a function of the time interval since the last flushing. The values of temperature and of time are given here purely as illustrations, and are not limiting, for the implementation of the control method S. This curve can for example be obtained by storing the successive results of the first calculation sub-step E311 of the control stage E31 of the first embodiment of the control method S1 in the memory 241.

Duration of the Flushing Interval and Assistance Utilization Time

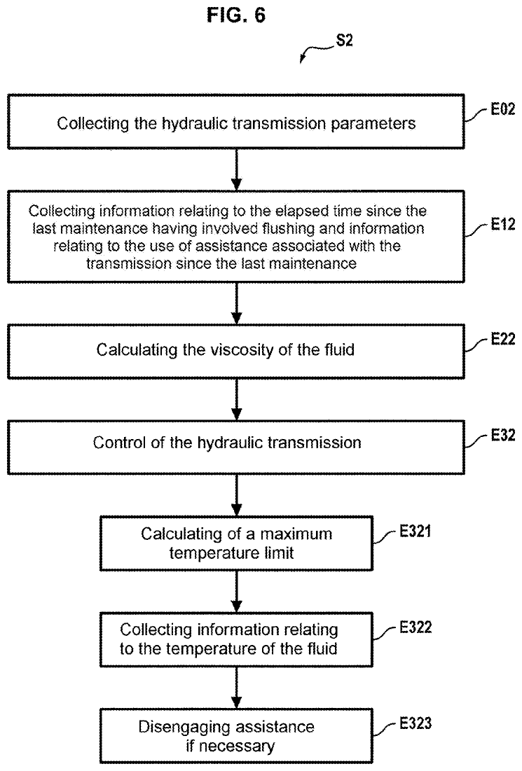

One variant S2 of the first embodiment S1 of the control method S of a hydraulic transmission for vehicles described above is illustrated in FIG. 6.

During a first step E12, information relating to the duration of use of the assistance associated with the hydraulic transmission since the last maintenance is also collected, by means 212 configured for this purpose.

During a second step E22 the calculation of the viscosity of the fluid is then implemented by the computer 24, and managed by the estimation means 22, depending on the information relating to the elapsed time since the last maintenance of the transmission and the information relating to the duration of use of the assistance associated with the hydraulic transmission since this last maintenance, said information having been collected during the collections step E12.

The preliminary step E02 and the third step E32, as well as the sub-steps E321 to E323, are identical to the first embodiment described previously, and are implemented by the same means 20, 23.

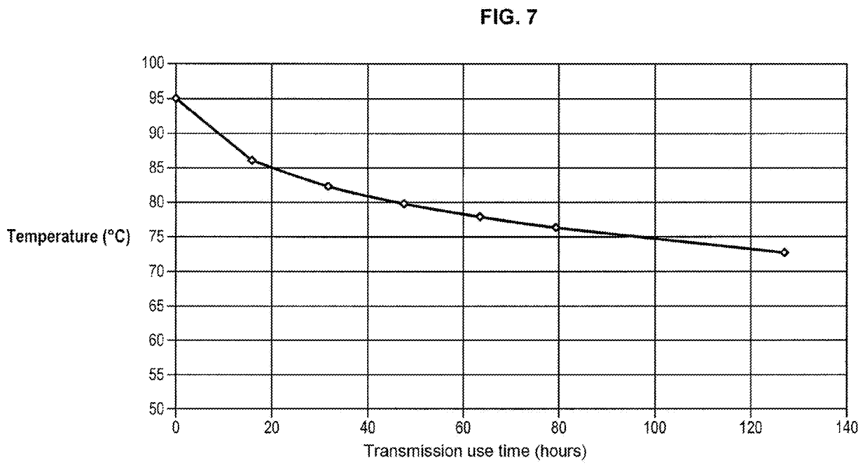

FIG. 7 illustrates an example of a curve providing the maximum temperature limit for disengagement of a hydraulic transmission for vehicles as a function of time, in the case where the use level is severe. The evolution over time is supplied as a function of the utilization time of the transmission 1. The values of temperature and time are given here purely illustratively, with no limitation, for the implementation of the control method S. This curve can for example be obtained by storing in the memory 241 the successive results of the first calculation sub-step E311 of the control step E31 of the first embodiment of the control method S1.

Real Time Estimation of the Fluid Quality

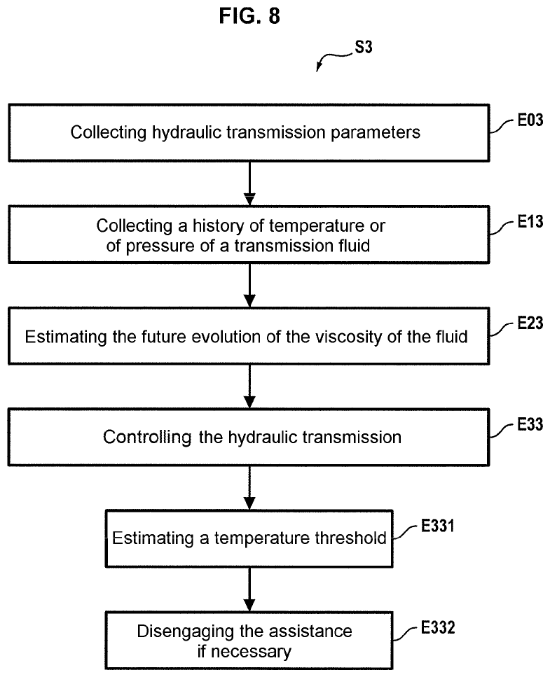

A second embodiment S3 of a control method S for a hydraulic transmission for vehicles is illustrated in FIG. 8.

A first step E13 consisting of collecting information relating to the operation of the hydraulic transmission consists of collecting, by means 213 configured for this purpose, a history of transmission fluid temperature or pressure. By history is meant information relating to periods during which the fluid has reached a given temperature level or a given pressure level in the high-pressure loop.

This step E13 can be carried out directly if the control system implementing the control method S comprises sensors 213 configured to provide information relating to the temperature of the fluid in circulation in the hydraulic transmission or to the pressure in the high-pressure loop of the transmission.

In the event of the absence of sensors 213 configured to provide information relating to the pressure in the high-pressure loop of the transmission, it is possible to use sensors 213 providing information relating to the speeds of the front and rear axles of the vehicle, and a sensor 213 providing information relating to temperature. The speed sensors 213 give access to the difference in speed between the hydraulic pump and the hydraulic motor in a closed circuit. Based on this speed difference value and a temperature value, it is possible to estimate the pressure found in the high-pressure pipes, as nearly as the dispersion of efficiencies of the transmission components will allow. Thus it is possible to provide the pressure history of the high-pressure loop of the transmission. This estimation step can for example be implemented by the computer 24, the history being stored incrementally inside the memory 241.

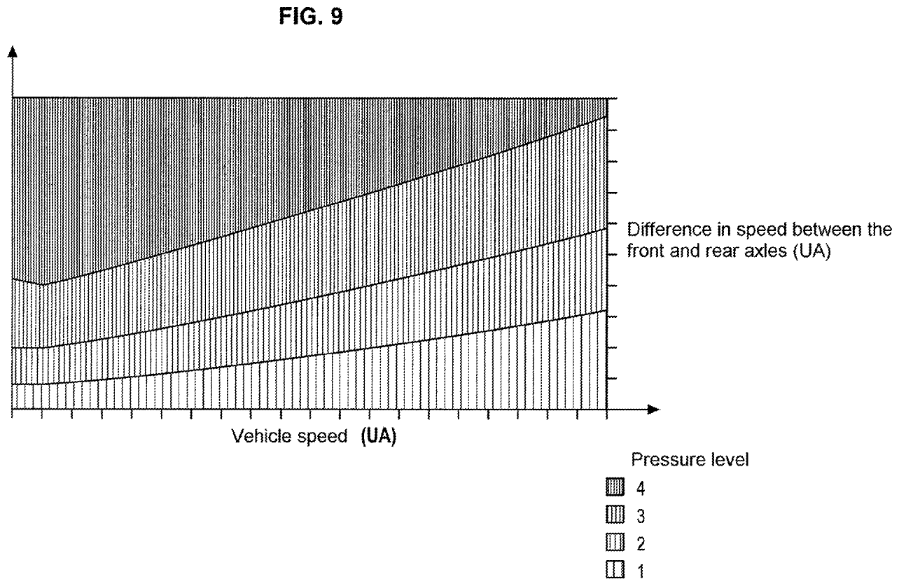

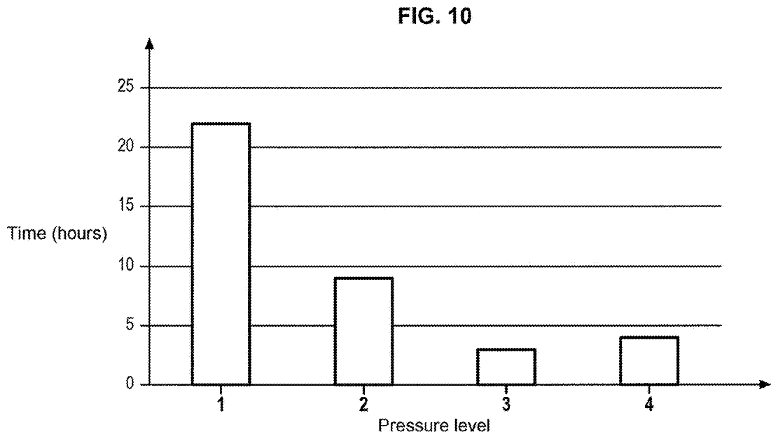

Illustrated in FIG. 9 is an example of cartography for providing an example of a pressure history of the high-pressure loop of a transmission. In FIG. 9, the speed of the vehicle is seen as the abscissa, and as the ordinate the difference in speed between the front axle and rear axle. To each point in the cartography, there corresponds a pressure level of the transmission fluid in the high-pressure loop of the hydraulic transmission 1, rising pressure levels corresponding to rising pressure. Thus the measurement of the speed of the vehicle and of the difference in speed between the front and rear axles gives direct access to the pressure in the high-pressure loop, and allows constructing a history as illustrated in FIG. 10.

With reference to FIG. 10, the history takes the form of a bar diagram providing the number of hours of operation of the transmission 1, the transmission fluid in the high-pressure loop being at a given pressure level.

A second step E23 of estimation of an ageing state of the transmission fluid is implemented thanks to the history collected during the collection step E13. To this end, it is possible in particular to estimate, by means 221 configured for this purpose, the evolution of the viscosity of the fluid during the operation of the transmission 1, as a function of the values of the pressure and temperature history received during the collection step E13.

A third control step E33, implemented by the control means 23, 231 comprises a first estimation sub-step E331, by the computer 24, of a temperature threshold that allows guaranteeing an optimal viscosity guaranteeing the safety of the system and of the user based on the future evolution estimated during the second step E23. This estimation can also use hydraulic transmission parameters collected during a preliminary step E03, similar to the preliminary steps E01, E02 previously described. From there, control actions as described previously can be considered during a second sub-step E332.

Steps of the control method S previously described can advantageously be implemented by a maintenance system 3, within a maintenance method M for hydraulic systems for vehicles. By hydraulic systems 1 is meant any device for vehicles involving the circulation and the pressurization of a working fluid. Systems 1 of this type comprise a filter F capable of limiting the pollution of the working fluid. A disengageable hydraulic transmission 1 as described previously is a non-limiting example of a hydraulic system 1.

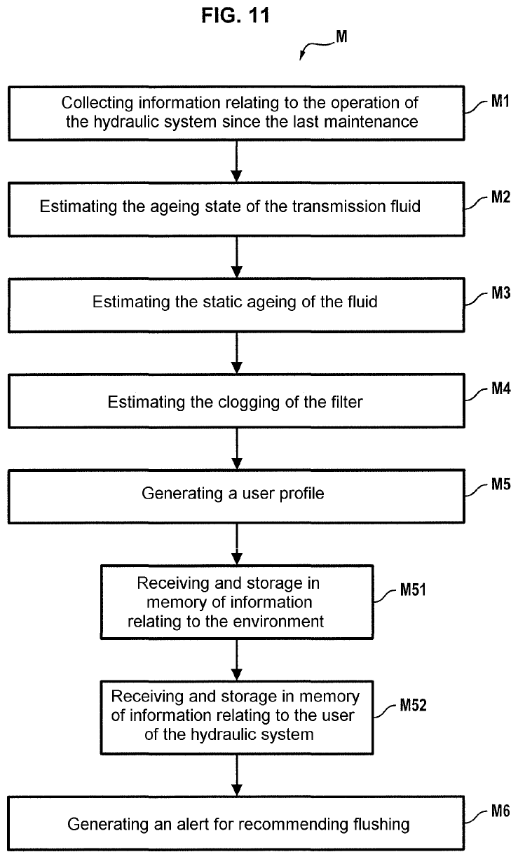

For the purpose of optimizing the frequency of maintenance of systems 1 of this type, it can be useful to have available information relating the ageing state of the working fluid. As illustrated in FIG. 11, one maintenance method M of a hydraulic system for vehicles can therefore advantageously comprise two first collection steps M1 of information relating to the operation of the hydraulic system since a last maintenance of the system, and estimation M2 of an ageing state of the working fluid based on the information collected. Such stems M1, M2 are similar to those previously described E1, E2 for the control method S of a hydraulic transmission, and are implemented by the same means 21, 22, 24 and can be common to or redundant with a control system 2 to which the maintenance system 3 can be coupled. The different embodiments of these steps E1, E2, and their variants, can also be implemented in a maintenance method M of this type.

The method can also comprise steps consisting of:
estimating the static ageing of the fluid M3, implemented by means 33 configured for this purpose,
estimating the clogging of the filter M4 implemented by means 34 configured for this purpose, and
generating a user profile M5, implemented by means 35 configured for this purpose.
   A method M of this type allows monitoring the overall state of the hydraulic system and associated with it a corresponding user profile. Advantageously, a method M of this type allows optimizing the maintenance intervals of a hydraulic system. This optimization makes hydraulic systems 1 safer, sturdier and more reliable.

The additional steps mentioned above will now be described in more detail.

Estimation of the Static Ageing of the Fluid M3

The static ageing of the oil is a degradation mode which affects primarily hydraulic systems receiving little use. The additives which compose the working fluids of these systems can degrade over time. This ageing mode can be measured based on the total acidity index of the fluid. This acidity has a tendency to drop early in a flushing interval, then experience a stable level, to finally increase again abruptly at the very end of its life.

A personalized maintenance method M can therefore comprise an additional step M3 during which information relating to the total acidity index of the fluid is received, then compared to a reference value supplied previously, so as to estimate the static ageing of the fluid.

It should be noted that the degradation of the fluid can appear inhomogeneous between the portion comprises in a part of the system farthest forward in the vehicle, and a part comprised in a part furthest to the rear.

Estimation of Clogging of the Filter M4

During an additional step M4 of the maintenance method, the clogging state of the filter is estimated.

This additional step M4 can be implemented by a clogging sensor 34 which supplies information relating to the clogging state of the filter.

Generation of a User Profile M5

The personalized maintenance method M can also comprise an additional step of generation of a user profile M5.

This step M5 comprises a first sub-step M51 of reception, implementation by means 351 configured for this purpose, of information relating to the environment in which the vehicle comprising the hydraulic system operates. It also comprises a sub-step M52 of reception, implementation by means 352 configured for this purpose, of information relating to the use of the hydraulic system.

The information relating to the environment can, without limitation, apply to the climate. In this case, the first reception sub-step M51 can comprise reception of information relating to the GPS (Global Positioning System) position of the vehicle, by means 3511 configured for that purpose. As a variant, this information can relate to the ambient temperature of the atmosphere surrounding the vehicle via for example a vehicle temperature sensor 3512. As a variant this information can relate to a geographic feature, for example that the user often travels in mountainous regions or often travels outside the road network.

The information relating to the use of the hydraulic system can be a fluid pressure history, a history of the respective speeds of the front and rear axles of the vehicle, or a history of the slopes on which the vehicle has traveled, or of geographic positions or of the type of terrain traveled over. In this case, the second reception sub-step M52 can comprise the reception of information relating to one of the histories previously described, implemented by the collection means 213 described previously.

This profile has in memory the information relating to the environment and to the use of the hydraulic system, and can be used by the user himself so as to optimize the frequency of maintenance. As a variant, this profile can be used by a professional providing maintenance, in order in particular to adjust the type of fluid used.

In any case, the maintenance method M previously described comprises a final step M6 for generating an alert, implemented by means 236 configured for this purpose, for recommending flushing of the working fluid depending on the estimated ageing state of the fluid. As a variant, the generation of an alert M6 can depend on the static ageing state of the fluid, or on the clogging state of the filter.

The control S and maintenance M methods previously described can be implemented by one (or more) system(s) 2, 3 having means configured for accomplishing the different steps of the methods, regardless of the embodiment. These means can in particular comprise a computer 24 having a memory 241 for storing control instructions. Advantageously, this memory 241 can load a computer program product comprising code instructions for the execution of the control S, and/or maintenance M, methods, as previously described. This program product can moreover advantageously be stored on a storage means readable by information processing equipment. These means can also comprise an interface 4 for reproducing information relating to the ageing state of the transmission fluid, alerts for signaling the necessity of carrying out maintenance, or reproduction of information relating to the user profile created during the corresponding step in the method M described.

1. A system for controlling a disengageable hydraulic transmission for vehicles, involving the circulation and the pressurization of a transmission fluid, said hydraulic transmission comprising:
a first hydraulic machine connected to a first axle of the vehicle, and a second hydraulic machine connected to a second axle of the vehicle, to provide additional and temporary wheel power, and
a set of pipes capable of routing the transmission fluid between the two hydraulic machines by means of at least one high-pressure line,
said system comprising:
means for collecting information relating to the operation of the hydraulic transmission since a last maintenance of the transmission,
means for estimating an ageing state of the transmission fluid based on the information collected, said means comprising means for estimating the viscosity of the transmission fluid, and
control means for the disengageable hydraulic transmission depending on the estimated ageing state so as to adapt the operation of the hydraulic transmission to preserve the longevity of the transmission parts of the hydraulic machines.

2. The system according to claim 1, wherein the means for collecting information relating to the operation of the hydraulic transmission comprise means for collecting information relating to the pressure or the temperature of the transmission fluid so as to establish a history of the temperature or pressure of the transmission fluid since the last maintenance of the transmission.

3. The system according to claim 1, wherein the control means of the disengageable hydraulic transmission comprise means for engaging or disengaging the disengageable hydraulic transmission.

4. The system according to claim 1, wherein the control means of the disengageable hydraulic transmission comprise means for limiting the use of the disengageable hydraulic transmission depending on the speed of the vehicle.

5. The system according to claim 1, wherein the control means of the disengageable hydraulic transmission comprise means for limiting the transmission torque.

6. The system according to claim 1, wherein the control means of the disengageable hydraulic transmission comprise alerting means for recommending flushing of the transmission fluid.

7. The system according to claim 1, wherein the means for estimating an ageing state of the transmission fluid comprise means for estimating the evolution of the viscosity of the fluid during operation of the transmission.

8. The system according to claim 1, wherein the set of pipes capable of routing the transmission fluid between the two hydraulic machines of the hydraulic transmission comprise a high-pressure line and a low-pressure line defining a closed loop.

9. The system according to claim 1, wherein the set of pipes capable of routing the transmission fluid between the two hydraulic machines defines an open loop with a low-pressure return to an oil reservoir.

10. The system according to claim 1, further comprising means for collecting information relating to the viscosity of the fluid, defining maximum and minimum fluid temperature thresholds beyond which the continuity and the safety of the system are involved.

11. A vehicle comprising a disengageable hydraulic transmission and further comprising a system according to claim 1.

12. A method for controlling a disengageable hydraulic transmission for vehicles, involving the circulation and the pressurization of a transmission fluid, said hydraulic transmission comprising:
a first hydraulic machine connected to a first axle of the vehicle, and a second hydraulic machine connected to a second axle of the vehicle to provide additional and temporary wheel power, and
a set of pipes capable of routing the transmission fluid between the two hydraulic machines by means of at least one high-pressure line,
the method comprising the steps of:
collecting information relating to the operation of the hydraulic transmission since a last maintenance of the transmission,
estimating an ageing state of the transmission fluid based on the information collected, said estimation step (E2) comprising a step of estimating the viscosity of the transmission fluid, and
controlling the disengageable hydraulic transmission depending on the estimated ageing state so as to adapt the operation of the hydraulic transmission to preserve the longevity of the transmission parts of the hydraulic machines.

13. The control method according to claim 12, wherein the step of collecting information relating to the operation of the hydraulic transmission comprises collecting information relating to the pressure or to the temperature of the transmission fluid so as to establish a history of the temperature or pressure of the transmission fluid since the last maintenance of the transmission.

14. The control method according to claim 13, wherein the step of estimating the ageing state of the transmission fluid comprises estimating the viscosity of the transmission fluid depending on the temperature of the transmission fluid and the established history.

15. The control method according to claim 12, wherein the control step comprises steps of engaging or disengaging the transmission system, or a step of limiting the transmission torque, or an alerting step for recommending flushing of the transmission fluid.
